(19) United States
(12) Patent Application Publication
(10) Pub. No.: US 2011/0138322 A1
(43) Pub. Date: Jun. 9, 2011

(54) Vehicular manipulation apparatus

(75) Inventor: Takashi Aoki, Gifu-city (JP)

(73) Assignee: DENSO CORPORATION

(21) Appl. No.: 12/928,019

(22) Filed: Dec. 1, 2010

(30) Foreign Application Priority Data
Dec. 3, 2009 (JP) 2009-275691

(51) Int. Cl. G06F 3/048

(52) U.S. Cl. 715/786; 715/781

(57) ABSTRACT

In a manipulation apparatus for a vehicle, a display device displays on a screen a manipulation window that is used for illustrating several manipulation manners performed by a composite manipulation device. In the manipulation window, an auxiliary image is displayed to move along a manipulation movement locus in a corresponding manipulation manner of the composite manipulation device for a user to recognize so as to be associated with the manipulation manner. The auxiliary image is displayed, in a selection region within the manipulation window, so as not to contain any superimposition continuation region, where the auxiliary image is superimposed on the manipulation window continuously for a predetermined duration.

### CROSS REFERENCE TO RELATED APPLICATION

The present application is based on and incorporates herein by reference Japanese Patent Application No. 2009-275691 filed on Dec. 3, 2009.

### FIELD OF THE INVENTION

The present invention relates to a vehicular manipulation apparatus to display several selection regions on a display screen and execute a selection manipulation to select one of the selection regions.

### BACKGROUND OF THE INVENTION

[Patent document 1] JP-2009-176432 A (US-2009/0183978)

For example, there is recently adopted a composite manipulation apparatus as a manipulation device in a vehicle so as to use intricately functions of in-vehicle devices. The composite manipulation device realizes several manipulation manners such as a rotating manipulation manner, a tilting manipulation manner, a two-dimensional sliding manipulation manner, and a push manipulation manner collectively in a single device body. Those manipulation manners are used to select several selection regions (command switches) drawn on the display screen (refer to Patent document 1).

When adopting such a composite manipulation device, the following becomes a matter to be solved. That is, manipulation images appear-on respective several selection regions in a display window on the display screen; then, a selection manipulation is performed so as to intend to select one of the manipulation images or one of the selection regions using the composite manipulation device. In such a case, it may be unclear for a user to use which one of the several manipulation manners for the intended selection manipulation.

For example, a composite manipulation device is provided with a rotating manipulation manner and a crisscross directional manipulation manner; thereby, a menu window is displayed in a display screen. The menu window contains four manipulation images (i.e., four selection regions), which are located respectively in a right upper portion, a left upper portion, a right lower portion, and a left lower portion, with respect to a center of the display screen (i.e., a center of the manipulation window). In other words, four manipulation images are located with respect to the center of the display screen, in a circular arrangement in order in sectional regions formed by crossing of the upper-lower dividing line and a right-left dividing line (hereinafter, referred to as a crisscross/circular arrangement). Such a crisscross/circular arrangement of the manipulation images may cause a user to recognize either a crisscross direction manipulation manner from the crisscross arrangement, or a rotating manipulation manner from the circular arrangement. This makes it difficult for the user to use which of the two manipulation manners to select a manipulation image. As a result, the user needs to try to perform either of the two manipulation manners for determining which one is correct. This poses botheration on the user. In contrast, if the manipulation manner is explicitly or clearly illustrated, for instance, by using the character display expressing the corresponding manipulation manner, the design performance is however degraded largely.

### SUMMARY OF THE INVENTION

It is an object to provide a vehicular manipulation apparatus to display an image allowing easy recognition of a manipulation manner without a design performance degraded largely in executing a selection manipulation applied to selection regions in a display window using a composite manipulation device.

To achieve the above object, according to an example of the present invention, a vehicular manipulation apparatus is provided in a vehicle as follows. A display device is included. A main display control section is configured to cause the display device to display on a screen of the display device a manipulation window that contains a plurality of selection regions. A selection manipulation device is configured to allow a selection manipulation to select one of the selection regions in the displayed manipulation window. The selection manipulation device is a composite manipulation device to enable each of a plurality of manipulation manners to independently achieve the selection manipulation. An auxiliary image display control section is configured to cause the display device to perform a dynamic display that displays on the manipulation window an auxiliary image that reflects a manipulation movement locus of the selection manipulation device, in order to indicate the manipulation manner corresponding to the manipulation window being displayed. Herein, the dynamic display performed by the auxiliary image display control section does not provide the selection regions with a superimposition continuation region, in which the auxiliary image is superimposed on the manipulation window continuously for a predetermined duration.

According to the above configuration, when manipulating the composite manipulation apparatus, a manipulation manner defined as a manipulation target can be easily determined by the auxiliary image on the manipulation window. In addition, the auxiliary image illustrates a manipulation movement locus of the manipulation manner defined as the manipulation target dynamically, i.e., as a dynamic display or a varying image. The manipulation direction can be thus instantaneously understood to thereby allow the start of the manipulation. In addition, the auxiliary image is displayed dynamically or as a varying image. This prevents the auxiliary image from existing in a fixed position or portion on the selection region and covering such a position continuously. That is, the display contents (images such as the control contents corresponding to manipulation) mainly displayed on the selection region can be certainly visible at least once within a given period; the display contents are not missed to see. In addition, if the movement of the auxiliary image is expressed to indicate the manipulation movement locus in the manipulation manner, the manipulation manner is much more easily recognizable.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating a configuration of a vehicular manipulation apparatus according to a first embodiment of the present invention;

FIG. 2 is a perspective view of a vehicle compartment accommodating the manipulation apparatus according to the present embodiment;

FIG. 3 is a diagram illustrating a first example of a composite manipulation device in the manipulation apparatus;

FIGS. 4A to 4C are diagrams for explaining manipulation manners of the composite manipulation device in FIG. 3;

FIG. 5 is a diagram illustrating an example of a present status display window;

FIG. 6 is a diagram illustrating a conventional example as a comparative example;

FIG. 7 is a diagram illustrating a first example of a manipulation window according to the present embodiment;

FIG. 8 is a diagram for explaining a movement of an auxiliary image in FIG. 7;

FIG. 9 is a diagram illustrating a display example of an auxiliary image in an intermediate layer display window;

FIG. 10 is a diagram illustrating a display example of an auxiliary image in a lowest layer display window;

FIG. 11 is a diagram illustrating a second example of a manipulation window according to the present embodiment;

FIG. 12 is a diagram for explaining a movement of an auxiliary image in FIG. 11;

FIG. 13 is a diagram illustrating a third example of a manipulation window according to the present embodiment;

FIG. 14 is a diagram for explaining a movement of an auxiliary image in FIG. 13;

FIG. 15 is a diagram illustrating a fourth example of a manipulation window according to the present embodiment;

FIG. 16 is a diagram for explaining a movement of an auxiliary image in FIG. 15;

FIG. 17 is a diagram illustrating a fifth example of a manipulation window according to the present embodiment;

FIG. 18 is a diagram illustrating a second example of a composite manipulation device in the manipulation apparatus;

FIG. 19 is a diagram illustrating a third example of a composite manipulation device in the manipulation apparatus;

FIG. 20 is a diagram illustrating a fourth example of a composite manipulation device in the manipulation apparatus;

FIG. 21 is a diagram illustrating a fifth example of a composite manipulation device in the manipulation apparatus;

FIG. 22 is a block diagram illustrating a configuration of a vehicular manipulation apparatus according to a second embodiment of the present invention;

FIG. 23 is a flowchart illustrating a highlight display process;

FIG. 24 is a diagram illustrating a first example of a highlight display;

FIG. 25 is a diagram illustrating a second example of a highlight display;

FIG. 26 is a diagram illustrating a third example of a highlight display; and

FIG. 27 is a diagram illustrating a fourth example of a highlight display.

### DETAILED DESCRIPTION OF THE PREFERRED EMBODIMENTS

Hereinafter, a vehicular manipulation apparatus according to an embodiment of the present invention is described with reference to the drawings.

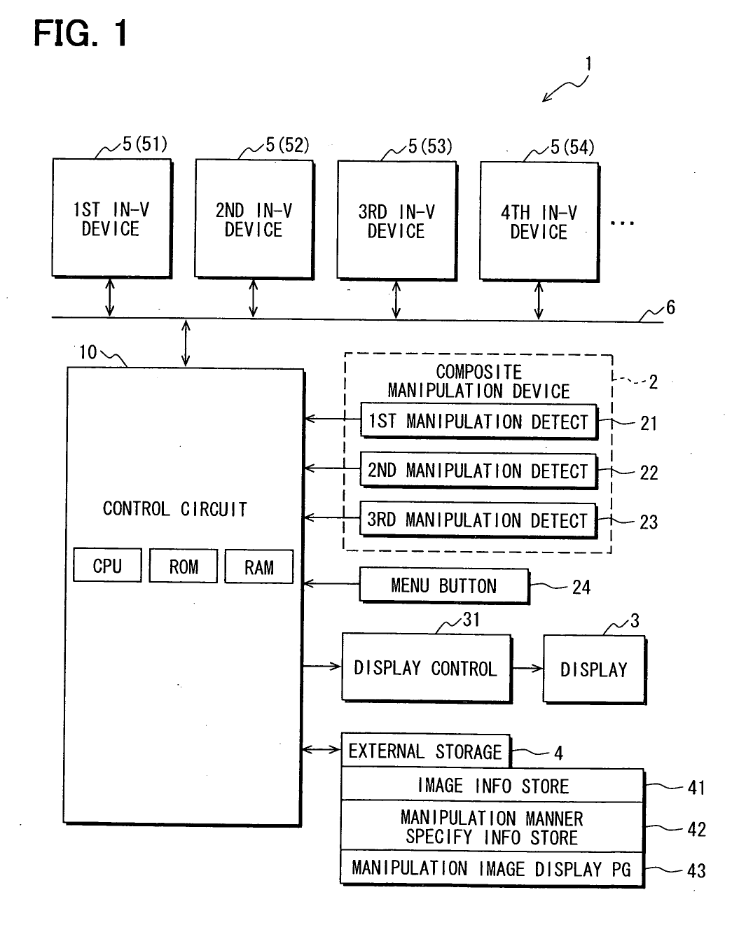

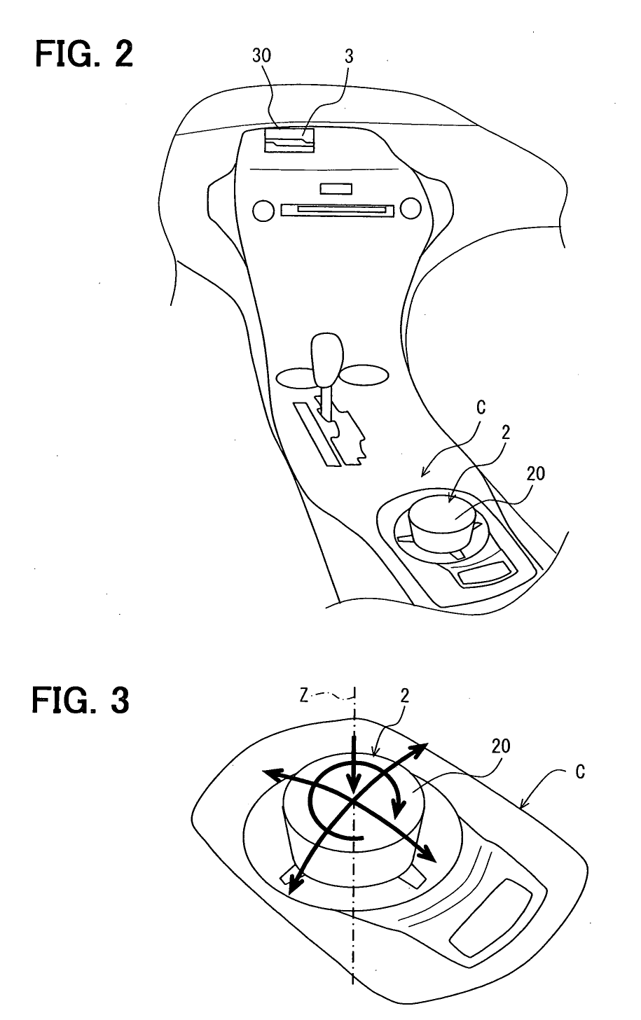

FIG. 1 is a block diagram illustrating a schematic configuration of a vehicular manipulation apparatus according to an embodiment of the present invention. The vehicular manipulation apparatus 1 is mounted in a subject vehicle. As shown in FIG. 1, the vehicular manipulation apparatus 1 includes the following: a display device (display means) 3; a control circuit (a main display control means or section) 10 which displays a manipulation window 300 with several selection regions 310 (command switches) on a display screen 30 (FIG. 2) of the display device 3; and a manipulation device 2 (i.e., a selection manipulation means or device) which allows a selection manipulation to select one of the several selection regions 310 in the displayed manipulation window 300. Furthermore, the manipulation device 2 is configured as a composite manipulation device 2 (composite manipulation means) to enable each of several manipulation manners to independently achieve a corresponding selection manipulation.

The display device 3 can use, for instance, a well-known liquid crystal display to display a static image and a moving image. The display device 3 is connected with the control circuit 10 via a display control circuit 31. The display device 3 is driven according to a display use driving signal outputted from the control circuit 10. In addition, the display device 3 is provided with various switches formed in the circumference of the display screen 30. For example, a menu switch 24 is included in the various switches. The menu switch 24 is connected with the control circuit 10 via a signal input device (unshown), and inputs an electrical signal to the control circuit 10 according to each manipulation. The menu switch 24 is a manipulation device which performs a window changeover to change a display window on the screen 30 of the display device 3 into a menu window 200 according to a manipulation.

The composite manipulation device 2 is arranged in a position separated from the position in which the display device 3 is arranged, as illustrated in FIG. 2. The composite manipulation device 2 serves as a remote manipulation means or device for executing remotely a manipulation input in the selection regions 310 of the display device 3. As a remote manipulation for selecting the selection regions 310 on the display screen 30 of the display device 3, the composite manipulation device 2 enables a manipulation to cause an indication image such as a cursor to move.

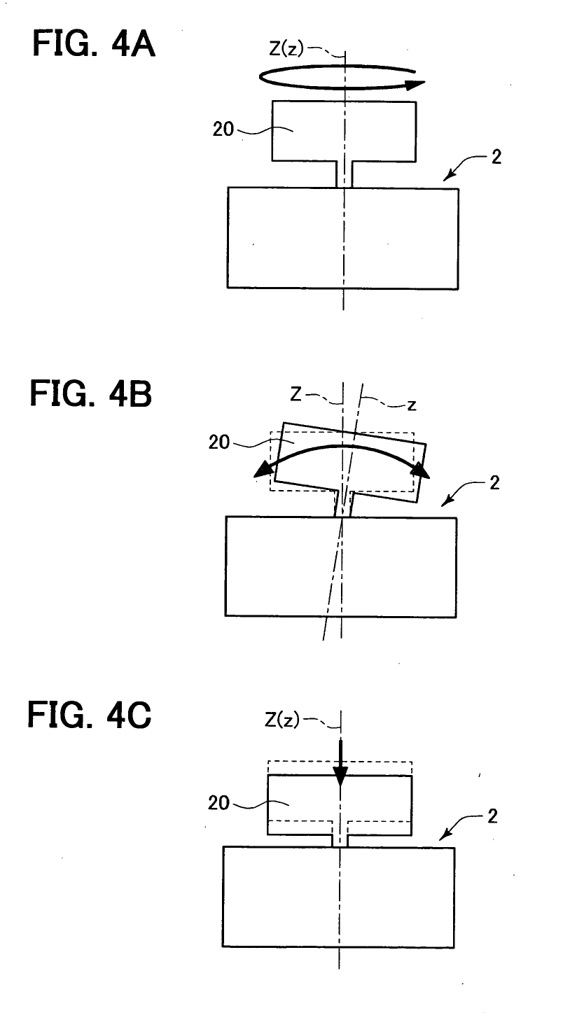

In addition, the composite manipulation device 2 has several manipulation manners. For instance, the several manipulation manners define respective manipulations as being directed to mutually different directions. As illustrated in FIG. 3, a single manipulation knob 20 (also referred to as a single manipulation handle 20) is provided with three different manipulation manners. The three manipulation manners have mutually different manipulation directions. In detail, in a rotating manipulation manner (see FIG. 4A), the manipulation knob 20 is rotated around an axis z of the manipulation knob 20 itself. In a shifting manipulation manner (see FIG. 4B), the manipulation knob 20 is shifted or moved such that the above axis z is shifted orthogonally with a reference axis Z, which accords with the axis z under a neutral position. In other words, when the axis z is shifted in one direction, the reference axis Z and the axis z are kept within a single identical plane while the shifting axis z draws a arc on the single identical plane. In a pressing manipulation manner, (also referred to as push manipulation manner, see FIG. 4C), the manipulation knob 20 is pressed in the axial direction of the above reference axis Z.

In the shifting manipulation manner of the present embodiment, the manipulation knob 20 is guided so as to move in one of several predetermined shifting manipulation directions. In detail, the shifting manipulation (also referred to as a tilt manipulation) is provided with a crisscross direction manipulation, in which the manipulation knob 20 can be moved or tilted in one of four crisscross directions from the reference position. It is noted that the shifting manipulation only needs to be designed such that the manipulation knob 20 moves or shifts in a direction orthogonal to the reference axis Z, i.e., the reference axis Z and the shifting axis z are kept on a single identical plane. The shifting manipulation may be designed such that the manipulation knob 20 is moved in a state that the axis z is moved in parallel with the reference axis Z. Further, the shifting manipulation may be a tilt manipulation of the whole of the manipulation knob 20 such that the axis z is tilted from a predetermined neutral position orthogonally to the reference axis Z. In addition, the directions of the shifting manipulation may be designed such that the manipulation knob 20 is moved, for instance, in two directions or three directions. In addition, the directions of the shifting manipulation may be designed such that the manipulation knob 20 is moved, for instance, in more than four directions such as six directions or eight directions.

According to the present embodiment, the composite manipulation device 2 is designed so as to move in four directions including the front-and-back directions and right-and-left directions of the vehicle. Of those manipulation directions, the front-and-back directions correspond to up-and-down directions in the display screen 30 on the display device 3; the right-and-left directions correspond to the right-and-left directions in the display screen 30 on the display device 3.

In addition, to enable the manipulation knob 20 is held in the reference position (i.e., neutral position) under a non-manipulation state, the composite manipulation device 2 is provided with a biasing means such as a spring member, and a, reactive force means such as a reactive force motor. In a casing of the device 2, several manipulation detection devices are provided to detect manipulations of the various manipulation manners against the manipulation knob 20. A first one is a rotating manipulation detection device 21, which detects electrically a rotating manipulation amount based on the rotating manipulation with respect to the manipulation knob 20. A second one is a shifting manipulation detection device 22 which detects a shifting manipulation with respect to the manipulation knob 20. A third one is a pressing manipulation detection device 23 which detects a pressing manipulation with respect to the manipulation knob 20. Those manipulation detection devices 21 to 23 are connected respectively with the control circuit 10 via a signal input device (unshown), and input electrical signals according to respective manipulations into the control circuit 10.

It is noted that the composite manipulation device 2 which can executes several manipulation manners using a single manipulation knob 20 is a well-known technology, as described in JP-200-176432 (Patent document 1) and JP-2009-064638; thus, the explanation of the detail internal structure of the manipulation knob 20 is omitted.

The control circuit 10 includes mainly a known microcomputer which has a CPU, a ROM, a RAM, etc. The control circuit 10 executes various controls by the CPU executing programs stored in a storage device such as the ROM, and an external storage device 4. In addition, the control circuit 10 can communicate data with other control circuits in other in-vehicle devices 5 (51 to 54) via an in-vehicle LAN 6. Further, the control circuit 10 can cause the in-vehicle device 5 to execute a device function by transmitting a control signal for executing a driving control of a control target of the other control circuit of the in-vehicle device 5. For example, the various functions of a navigation apparatus 51, air-conditioning apparatus 52, car audio 53, and other in-vehicle device 54, which are connected via the in-vehicle LAN 6, can be executed.

In addition, the control circuit 10 functions as a control execution means or device to execute corresponding control, based on the control input signal received from the manipulation detection devices 21 to 24. In addition, the storage device such as the ROM of the control circuit 10 and the external storage device 4 store image data for displaying various display windows. The image data is for display images such as a background image, and a manipulation image superimposed to or synthesized into the background image. The control circuit 10 reads the image data at a necessary time and displays an image based on the read data on the display screen 30 of the display device 3. In addition, each manipulation window is associated with a dedicated manipulation manner in which a manipulation is accepted in the each manipulation window. The above storage device stores manipulation manner specification information to specify a dedicated manipulation manner associated with each manipulation window, and a control content which is executed according to the received manipulation.

The external storage device 4 is connected with the control circuit 10 while functioning as image information storage device 41 to store image data for displaying each manipulation window 300 and a manipulation manner specification information storage device 42 to store manipulation manner specification information to specify a dedicated manipulation manner which is accepted when each manipulation window 300 is displayed. Furthermore, the image information storage device 41 stores an auxiliary image 320 corresponding to the image information or manipulation manner specification information in association with the image information or manipulation manner specification information each image information. Thus, the image information storage device 41 may be referred to as an auxiliary image storage device. The auxiliary image 320 is mentioned later.

When the manipulation window 300 is displayed on the screen 30 of the display device 3, the control circuit 10 displays a main image which is generated by superimposing or synthesizing corresponding manipulation image to the respective selection regions 310 on the background image corresponding to the manipulation window 300. One of the selection regions 310 (manipulation images) is selected by a manipulation by the composite manipulation device 2; further, a determination input manipulation is made to the selected selection region 310 (manipulation image). Then, the control circuit 10 executes a control corresponding to the selection region 310 (manipulation image). The determination input manipulation is assigned to a manipulation manner different from that of the selection manipulation. In the present embodiment, a pressing manipulation is assigned as the determination input manipulation. The pressing manipulation is made such that the manipulation knob 20 is pressed to the axial direction of the reference axis Z.

Then, to be associated with a manipulation manner of the composite manipulation device 2 for selecting each selection region 310 (manipulation image) on the manipulation window 300, i.e., a manipulation manner responding to (i.e., compliant with) the manipulation window 300, an auxiliary image 320 is displayed so as to reflect a manipulation movement locus in the corresponding manipulation manner of the composite manipulation device 2, dynamically, i.e., as a dynamic display or a varying image like an animation in superimposition or synthesis into the main image. Thereby, when the manipulation window 300 currently displayed on the display device 3 is manipulated, the manipulation manner of the composite manipulation device 2, which is defined a manipulation target, is easily recognized by the auxiliary image 320 displayed on the manipulation window 300.

In the present embodiment, the above auxiliary image 310 is displayed dynamically (e.g., as a time-based varying image) so as to be an image shaped to reflect the manipulation movement locus of the manipulation manner corresponding to the manipulation window 300 currently displayed. Such a dynamic display prevents the existence of a superimposition continuation region in which the auxiliary image 320 continues to overlap the background in the selection region 310 of the manipulation window 300 for a predetermined period. That is, dynamically displaying the auxiliary image 320a can prevent the selection region 310 from having a portion in which the auxiliary image 320 always overlaps, and the whole portions of the section region 310 can be seen at least once in a duration in which a predetermined period elapses. The portion which the auxiliary image 320 hides is also changed into a visible status since the auxiliary image 320 does not continue stopping at a fixed position. Any image or any character displayed in the selection region 310 being a selection target is certainly visible at least once for the predetermined period. A user does not miss, in the selection region 310, the recognition of the display of an image or character, which expresses a corresponding control content.

The following explains a manipulation window display process executed by the control circuit 100. As a manipulation window display program 43 stored in the external storage device 4 is executed, a window switchover request signal is inputted from the composite manipulation device 2, other manipulation devices, external control circuit, etc. In conjunction, a new manipulation window 300 according to the signal is displayed. In detail, the image information of the new manipulation window 300 corresponding to the display request is read out from the image information storage device 41. While displaying the manipulation window 300 based on the image information (main display control means or section), the control circuit 10 reads out the manipulation manner specification information corresponding to the image information of the manipulation window 300 from the manipulation manner specification information storage device 42. The manipulation manner of the manipulation window 300 displayed based on the image information is specified (manipulation manner specification means or section). An input of a selection manipulation by the specified manipulation manner is designated to be receivable by the composite manipulation device 2 (manipulation manner designation means or selection). Further, the control circuit 10 reads the image information of the auxiliary image 320 reflecting the manipulation movement locus of the composite manipulation device 2 in the specified manipulation manner from the auxiliary image storage device 43. The auxiliary image 320 based on the image information is displayed on the new manipulation window 300 corresponding to the display request (auxiliary image display control means or section).

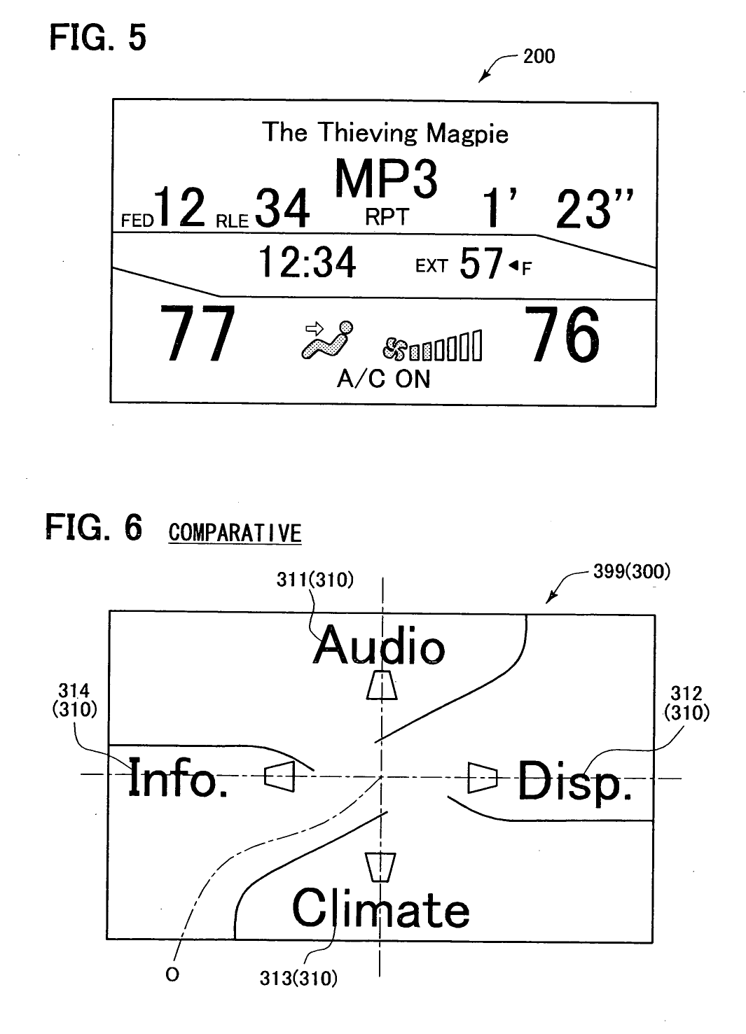

The following explains a display example of a Manipulation window 300 displayed on the screen 30 of the display device 3 according to the present embodiment. For example, FIG. 5 shows a present status display window 200 which displays vehicle information such as a present control status and present detection information of the various in-vehicle devices 5. In FIG. 5, the reproduction information of the audio, the setup information of the air-conditioner, the time clock of the clock, etc. are displayed. In cases that the menu switch 24 is manipulated in this status, i.e., while the present status display window 200 is displayed, a display window is switched from the present status display window 200 into a menu window 399 (manipulation window 300) shown in FIG. 6, in a conventional case, which is explained as a comparative example.

In the menu window 399 of FIG. 6, a circular arrangement of several selection regions 310 is made so as to arrange with every predetermined interval in a circle around a predetermined window reference point 0 on the screen 30. Furthermore, in more detail, respective regions 311 to 314 which form the selection regions 310 in a Crisscross figuration (four directions: upper, lower, right, and left) centering on the window reference point O. Suppose a case that a user intends to perform a manipulation to select the selection regions 311 to 314 using the composite manipulation device 2. In such a case, it is difficult for the user to intuitively determine whether selecting the selection regions 311 to 314 is made by the rotating manipulation or by the shifting manipulation from the display contents of the manipulation window 399. The rotating manipulation is made such that the manipulation knob 20 of the composite manipulation device 2 is rotated to select the selection regions 311 to 314. The shifting manipulation is made such that the manipulation knob 20 is moved into one of the directions forming a crisscross to select the selection regions 311 to 314. The manipulation window 399 in FIG. 5 is actually assigned with a shifting manipulation to move in crisscross directions to select the respective selection regions 311 to 314. However, in the design of the manipulation window 399 currently displayed has a characteristic to be associated with a rotation of a windmill; thus, it is apt for the user to be convinced that selecting regions be made via a rotating manipulation manner. In detail, in each selection region 311 to 314, a manipulation image includes a highlight portion (herein, a lineal image) in the same side of the circular direction centering on the display reference point O while being superimposed on the background image. Thus, such a design may be associated with the rotation of the windmill.

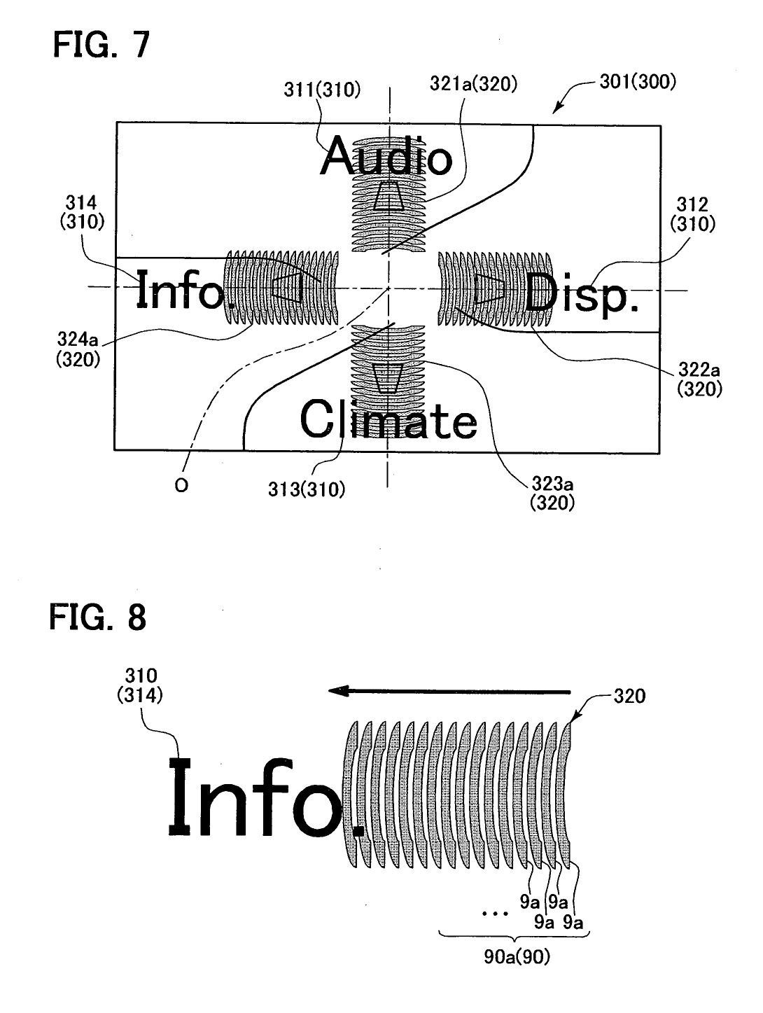

In contrast, while the same design associated with the rotation of the windmill in FIG. 6 is similarly displayed, a manipulation window 300 according to the present embodiment enables a user to certainly suppose the manipulation window 300 with a corresponding manipulation manner. That is, in cases that the menu switch 24 is manipulated while the present status display window 200 is displayed as in FIG. 5, a display window is switched from the present status display window 200 into a menu window 301 (manipulation window 300) shown in FIG. 7.

The menu window 301 (manipulation window 300) in FIG. 7 is a manipulation window responding to (i.e., compliant with) the shifting manipulation manner. The selection regions 310 are disposed in a circular arrangement centering on the window reference point O such that the relation of the reference position of the manipulation knob 20 and each shifting manipulation direction in the composite manipulation device 2 corresponds to the relation of the window reference point O on the screen 30 and each arrangement direction of the selection regions 310 against the window reference point O. The manipulation knob 20 is movable from a neutral position to the respective front, rear, right and left directions of the crisscross. The selection regions 310 are disposed in a crisscross arrangement in four front, back, right, and left directions on the screen 30 while centering on the window central point O. The auxiliary image 320 is displayed dynamically (i.e., as a varying image) so as to reflect the manipulation movement locus of the composite manipulation device 2 in the manipulation manner corresponding to the manipulation window 301. The dynamic display uses an auxiliary image 320, which is another image different from the display contents in the selection region 310 of the manipulation window 300. The auxiliary image 320 is displayed in an animation display in superimposition on the main image which displays the manipulation window 300.

Each auxiliary image 320 is overlapped with a part of each selection region 310 at least. Each auxiliary image 320 is displayed in a semi transmission state. Each selection region 310 located in the background can be thus seen at any time. However, it cannot be always seen thoroughly; thus, if the display state (i.e., the static state of the auxiliary image 320) of FIG. 7 continues, the above superimposition continuation region continues. To solve the issue, each auxiliary image 320 is dynamically displayed so as to the above superimposition continuation region from existing in the selection region 310 in the manipulation window 300. In the present embodiment, such a dynamic display of the auxiliary image 320 is made not only in the selection regions 310 but also in the whole of the manipulation window 300 so as to prevent the above superimposition continuation region from existing. Thereby, the display contents (manipulation windows for a map or radio) currently displayed on the window 30 can also certainly, be seen at a time within a predetermined period; this can help prevent the recognition of the display contents from being missed.

In addition, in the present example, as shown in FIG. 8, the dynamic display is expressed in a form in which a figure or image moves along the manipulation movement locus of the composite manipulation device 2 in the manipulation manner of the manipulation window 300. That is, the manipulation movement locus of the composite manipulation device 2 in the manipulation manner corresponding to the manipulation window 301 is expressed not only by the display contents of the auxiliary image 320 but also by the dynamic movement of the display contents. The Movement of the figure which goes to the corresponding selection region 310 from the side of the window reference point O can express both the manipulation movement locus and the manipulation direction. Further, one or both of the above manipulation movement locus and the above manipulation direction can be expressed by only the motion of the display contents of the auxiliary image 320.

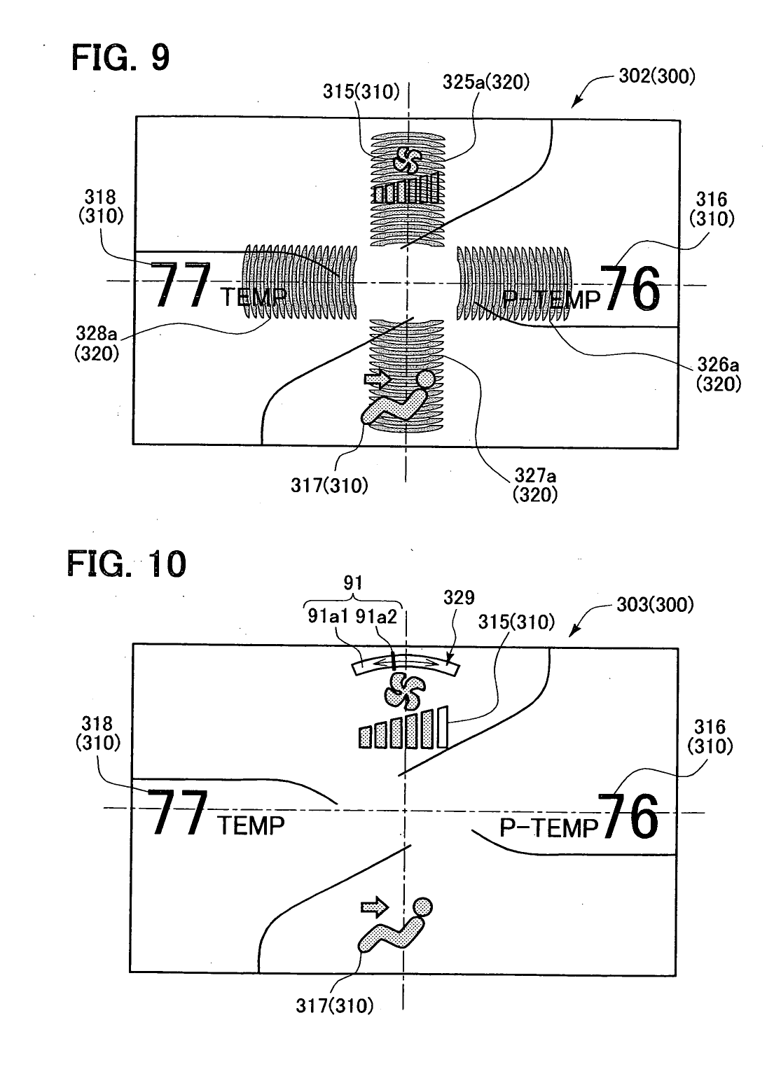

In more detail, the manipulation window 301 in FIGS. 7, 8 displays, as the auxiliary image 320, an auxiliary figure group 90 (herein, 90a) containing several auxiliary FIG. 9 arranged in a row or set in an array (herein, 9a). Such a direction of the array of the auxiliary FIG. 9 illustrates a manipulation movement locus of the composite manipulation device 2 in the manipulation manner of the present manipulation window 301. The auxiliary FIG. 9a in FIG. 7 are arc-shaped figures arranged to protrude towards the corresponding selection region 310 and disposed in an arrangement illustrating a waves continuously rippling formation with predetermined intervals to be directed towards the selection region 310 in an image. The several auxiliary FIG. 9a contained in each auxiliary figure group 90 are displayed in a movement display of moving towards the direction of the arrangement within a predetermined range. This configuration can indicate a manipulation directed to a corresponding selection region or a manipulation direction. The auxiliary FIG. 9 are displayed only within the predetermined region, and not displayed outside of the predetermined region.

In more detail, the manipulation window 301 in FIGS. 7, 8 is designed to respond to a shifting manipulation manner. The auxiliary image 320 (321a to 324a) is provided to correspond o each selection region 310 (311 to 314). Each auxiliary image 321a to 324a expresses dynamically a manipulating direction, which goes to the corresponding selection region 311 to 314 from the window reference point O, and a manipulation movement locus. In addition, there is a superimposition region in which an auxiliary image 321a to 324a is superimposed on the selection region 311 to 314 on the screen 30 within a lapse of a predetermined period. Such superimposition can explicitly indicate a correspondence relation between the auxiliary image 320 (321a to 324a) and the selection region 310 (311 to 314).

In the menu window 301 (manipulation window 300) in FIG. 7, a single selection region 310 is selected by the selection manipulation (herein, in a shifting manipulation manner) by the composite manipulation device 2. When the determination input manipulation (herein, in a pressing manipulation manner) is further made to the selection region 310, the display window is changed into the next manipulation window. In the present embodiment, menu windows such as a menu window in FIG. 7 are provided in several layers. After the selection manipulation and the determination input manipulation are repeatedly made in the several menu windows to reach a lowest layered window, the final control content is determined in the reached lowest layered window. In the present embodiment, intermediate layers are provided with a manipulation window in which selection regions 310 are selected by a shifting manipulation manner and then determined by a determination input manipulation, like in FIG. 7. In the lowest layered window, a control content which serves as an execution target is selected by one or both of a rotating manipulation and a shifting manipulation; then, the selected control content is executed by a determination input manipulation.

FIG. 9 shows a manipulation window 302 as an example of the lowest layered window in the present embodiment. In this manipulation window 302, first, the selection regions 310 are selected by a shifting manipulation manner. As illustrated in FIG. 10, when one of the selection regions 310 (315 to 318) is selected, a specific control content of a control item corresponding to the selected selection region 310 is selected by a rotating manipulation manner; then, the selected control content is executed by a determination input manipulation. It is noted that the control item contains several control contents, which are serialized in a predetermined number order. Such serialized control contents are selected in a manipulation to forward or return in order using a rotating manipulation manner. When selecting or designating a detailed set-up after the final control item is determined, there may be existing many choices. In such a case, (i) a selection by a rotating manipulation and (i) a scroll display window for displaying a selection content corresponding to the rotating manipulation are effective and useful.

In the manipulation window 302 (300) in FIG. 9, so as to indicate that a manipulation by the shifting manipulation manner can be received, the same auxiliary image 320 (325 to 328) as that in FIG. 7 is displayed. Next, in cases that the selection region 310 is selected in the manipulation window 302 in FIG. 9 and the manipulation window 302 becomes in a selected state, a manipulation window 303 (300) illustrated in FIG. 10 is displayed. In the manipulation window 303 in FIG. 10, so as to indicate that a manipulation by a rotating manipulation manner can be received in the present selected state, an auxiliary image 329 (320) is displayed only in the selection region 310 (315 to 318) which is selected. The auxiliary image 329 (91) has a first curving belt-like auxiliary FIG. 91a1 the curved shape of which indicates a rotating manipulation manner at a fixed position. Furthermore, the auxiliary image 329 (91) has a second auxiliary FIG. 91a2 that reciprocates along the fixed first auxiliary FIG. 91a1 while also indicating the rotating manipulation manner. The manipulation window 303 in FIG. 10 is designed to receive also a shifting manipulation manner; thus, the selection region 310 under selection can be changed into another selection region 310 by the shifting manipulation.

In the vehicular manipulation apparatus 1 according to the present embodiment, the composite manipulation device 2 is arranged at a predetermined position close to a seat as an auxiliary manipulation device to reduce a manipulation load of a user as compared with a main manipulation device. In the present embodiment, as illustrated in FIG. 2, the composite manipulation device 2 is arranged in a position, which can be reached by users who are seated in vehicular seats while leaning on backrests of the seats. In detail, the composite manipulation device 2 is arranged in a region C (herein, a center console) intervening between a vehicular right seat and a vehicular left seat (i.e., the driver seat and the passenger seat) of the vehicle. In contrast, as compared with position of the composite manipulation device 2, the display device 3 is arranged in a position closer to the front of the vehicle so as to enable the users seated in the respective seats to see.

The example of the present embodiment is explained in the above; however, such an example is only one example. The present embodiment need not be limited to the above example, and can be varied in various manners based on the knowledge of a person skilled in the art unless deviating from the scope of the claims. The following describes another embodiment.

Although the selection of the selection regions 310 (manipulation image) is enabled by the shifting manipulation manner in the above embodiment, another manipulation manner can be adopted as long as the following condition is satisfied. That is, a manipulation window 300 displays an auxiliary image 320 which reflects a manipulation movement locus of the manipulation manner; at the same time, the auxiliary image 320 appears dynamically as a time-based varying image so as to prevent a superimposition continuation region from existing at least within a selection region 310 in the manipulation window 300.

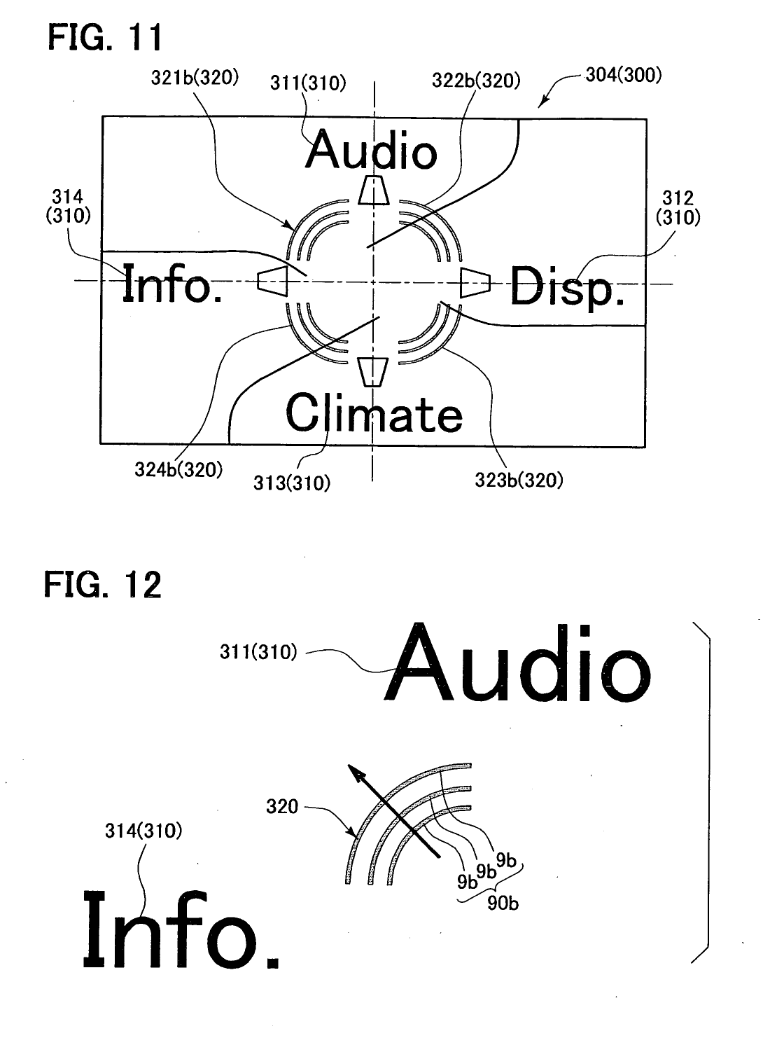

For example, the selection manipulation for selecting selection regions (manipulation images) 310 in the manipulation window 300 can be made by a manipulation in the rotating manipulation manner in the composite manipulation device 2. Display examples of auxiliary images 320 in such a rotating manipulation manner are illustrated in FIGS. 11, 13, 15, and 17.

In FIGS. 11, 12, a manipulation window 304 (300) displays as an auxiliary image 320 (321b to 324b) an arc-shaped auxiliary figure group 90b in a display range intervening between mutually adjoining selection regions 310 (manipulation images) of the four selection regions 310 existing in a circular arrangement with predetermined intervals. In FIG. 12, the auxiliary figure group 90b contains several curved or arc-shaped auxiliary FIG. 9b (herein, three (3)) arranged in order in a radial direction of the auxiliary FIG. 9b. The auxiliary figure group 90b existing on the manipulation window 304 can be seen in a circular formation as a whole, which reflects a manipulation movement locus in the rotating manipulation manner. Further, as illustrated in FIG. 12, a dynamic display for the auxiliary FIG. 9b to move outwardly in the radial direction may be adopted so as to prevent a superimposing continuation region from existing or arising. Such a case, however, does not indicate a manipulation direction of the composite manipulation device 2 in the rotating manipulation manner.

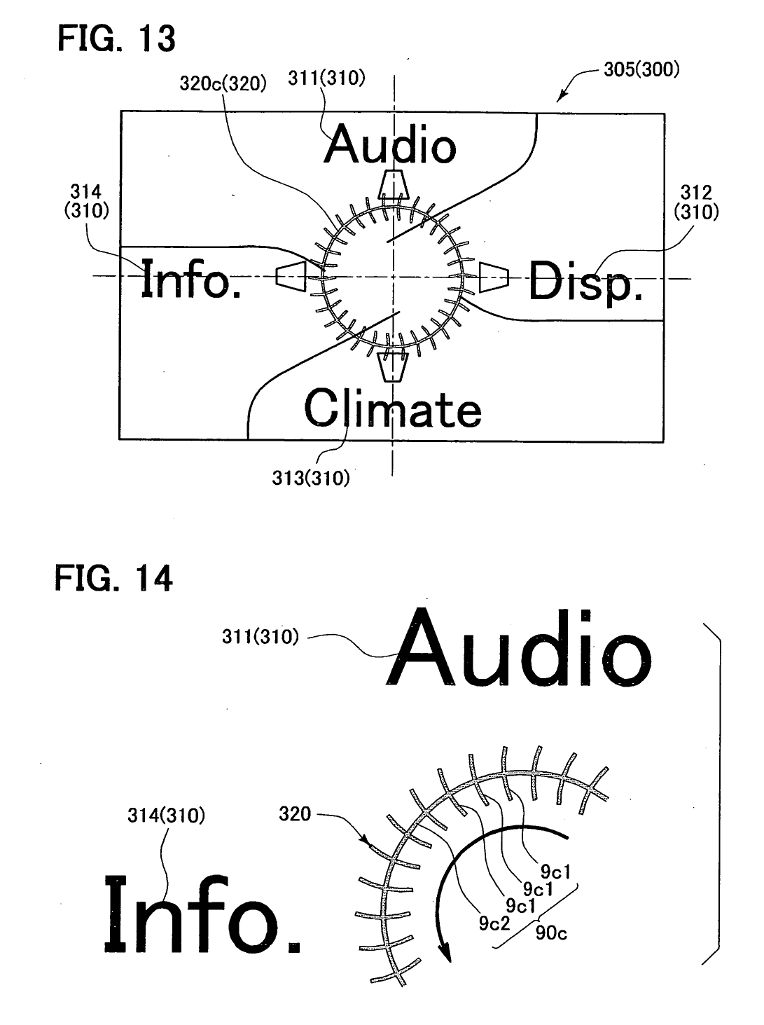

In FIGS. 13, 14, a manipulation window 305 (300) displays as an auxiliary image 320 (320c) an auxiliary figure group 90c in a display range surrounded by four selection regions 310 (manipulation images) existing in a circular arrangement with predetermined intervals. Further, the auxiliary figure group 90c contains a circular auxiliary FIG. 9c2 and arc-shaped auxiliary FIG. 9c1 serially arranged along the circumference of the circular auxiliary FIG. 9c2 with predetermined intervals. As illustrated in FIG. 14, the circular auxiliary FIG. 9c2 in FIG. 13 is displayed in a fixed state to reflect a manipulation movement locus of the rotating manipulation manner. In contrast, the arc-shaped auxiliary FIG. 9c1 may be displayed as a dynamic image to move along the circumference of the circular auxiliary FIG. 9c2, which is displayed in a stationary state to illustrate a manipulation movement locus of the rotating manipulation manner. Thereby, the dynamic display is at least enabled to reflect the manipulation movement locus of the rotating manipulation manner in this example. For example, the dynamic display can be made in (i) a reciprocation movement, in which the auxiliary FIG. 9c1 in the circumference of the static auxiliary FIG. 9c2, or (ii) a one-directional rotational movement along the circumference of the static auxiliary FIG. 9c2.

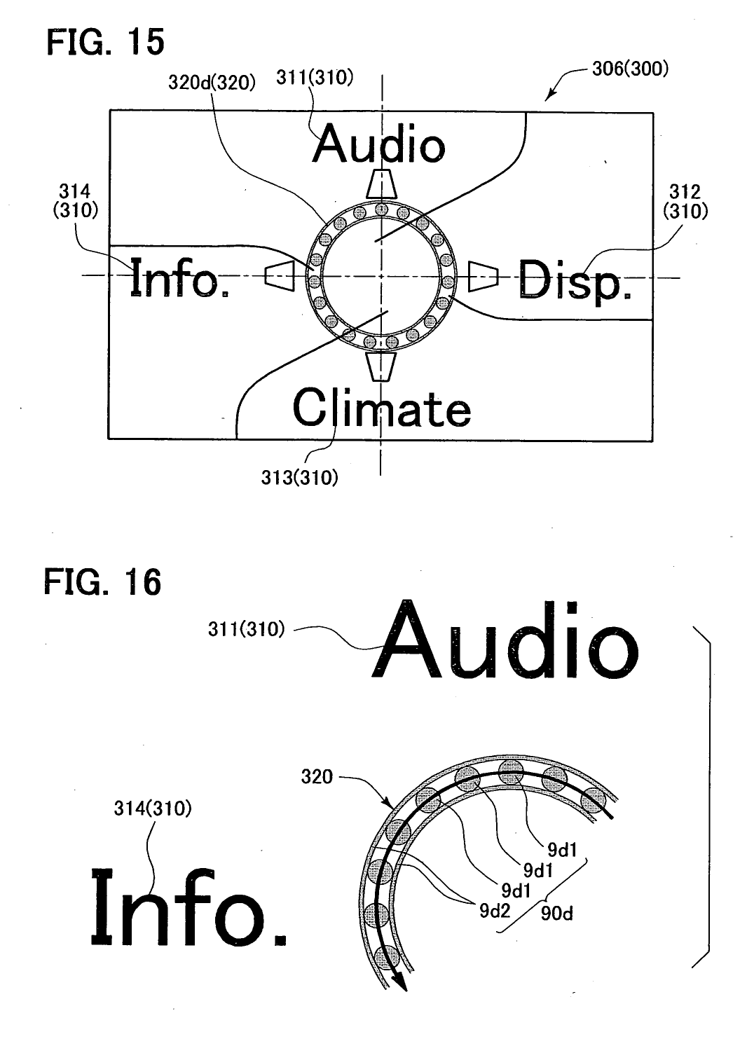

In FIGS. 15, 16, a manipulation window 306 (300) displays as an auxiliary image 320 (320d) an auxiliary figure group 90d in a display range surrounded by the four selection regions 310 (manipulation images) existing in a circular arrangement with predetermined intervals. Further, the auxiliary figure group 90d contains a concentric-double-circular auxiliary FIG. 9d2 and round auxiliary FIG. 9d1 serially and circularly arranged within the double-circular auxiliary FIG. 9c2 with predetermined intervals. As illustrated in FIG. 16, the auxiliary FIG. 9d2 of the double-circular formation is displayed in a static state so as to reflect the manipulation movement locus of the rotating manipulation manner. In contrast, the round-shaped auxiliary FIG. 9d1 may be displayed in a dynamic image to move circularly within the double-circular auxiliary FIG. 9d2. Such a dynamic display also reflects a manipulation movement locus of the rotating manipulation manner. For example, the dynamic display can be made in (i) a reciprocation movement, in which the auxiliary FIG. 9d1 in a range along the circumference of the static auxiliary FIG. 9d2, or (ii) a one-directional rotational movement along the static auxiliary FIG. 9d2.

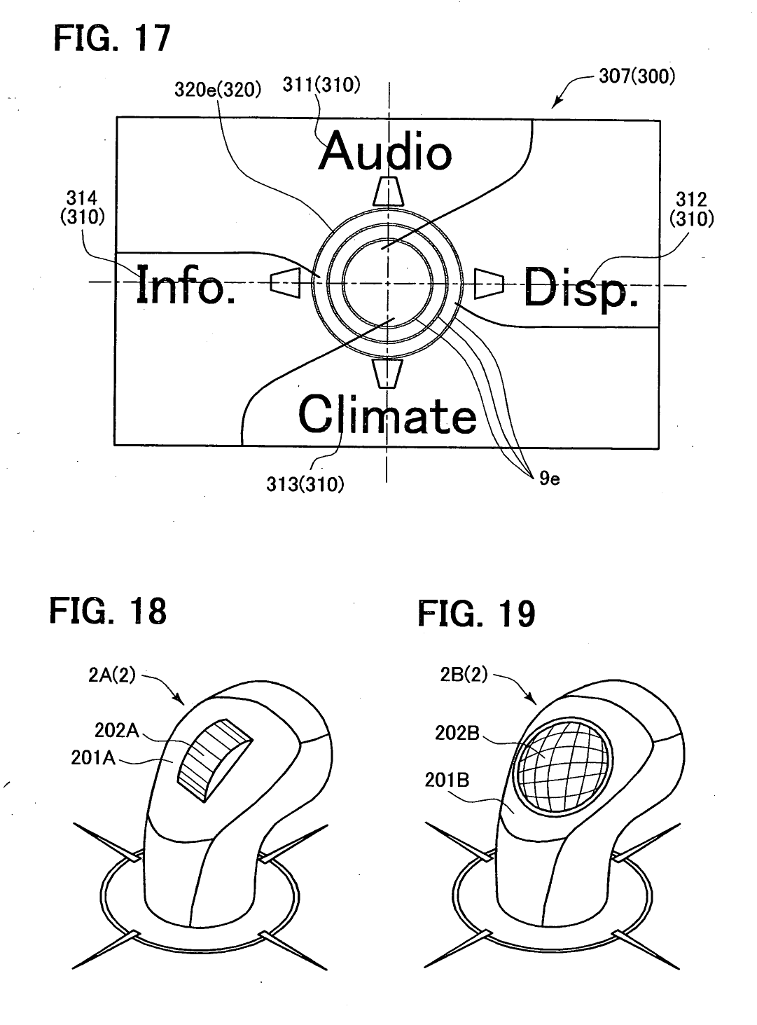

In FIG. 17, a manipulation window 307 (300) displays as an auxiliary image 320 (320e) a circular auxiliary FIG. 9e, which contains triple concentric circles in a display range surrounded by the four selection regions 310 (manipulation images) existing in a circular arrangement with predetermined intervals. Further, the auxiliary FIG. 9e provides a dynamic display by blinking with predetermined time intervals.

Further, the present embodiment has a characteristic that the selection regions 310 of the manipulation window 300 does not contain any superimposition continuation region in which an auxiliary image 320 continues to be superimposed for all the duration of a predetermined period. In contrast, the superimposition continuation region may be contained within the whole of the main image of the manipulation window 300. However, it is naturally better for the superimposition continuation region not to exist even in the main image.

Further, in the present embodiment, the dynamic display of the auxiliary image 320 can be made such that the display contents are modified dynamically. For example, the manipulation image superimposed on the selection region 310 may be dynamically modified. In detail, some or all of the manipulation image are distorted towards a direction of the manipulation movement locus or the manipulating direction, expressing a dynamic deformation or modification. This can indicate the manipulation movement locus or manipulation direction in the manipulation manner. Thereby, the manipulation manner can be easily recognized only by the modification or deformation of the manipulation image. Furthermore, any combination with an embodiment using another auxiliary image may be achieved.

In addition, the composite manipulation device 2 in the present invention can be provided with several different manipulation knobs. For example, each of such several knobs may be designed to have one or more manipulation manners. For example, a composite manipulation device 2 contains a first manipulation knob 210 (20) and a second manipulation knob 202 (20). The first manipulation knob 210 (20) is assigned with a rotating manipulation manner to rotate about a predetermined rotation axis; the second manipulation knob 202 (20) is assigned with a shifting manipulation manner to move in line on a predetermined plane. These two manipulation knobs or portions can allow at least two kinds of manipulation manners. Such a case also provides a user with the following confusion similar to the already described examples. That is, in cases that the screen 30 of the display device 30 displays one or both of a manipulation window 300 responding to the rotating manipulation manner, and a manipulation window 300 responding to the shifting manipulation manner, several selection regions 310 are displayed in a circular arrangement to exist with predetermined intervals in a circular formation around a predetermined window reference point O on the screen 30. In such a case, it is difficult for a user to correctly make a determination as to whether to manipulate the first manipulation knob 201 or the second manipulation knob 202. Displaying the above auxiliary image 320 enables the user to correctly make the determination.

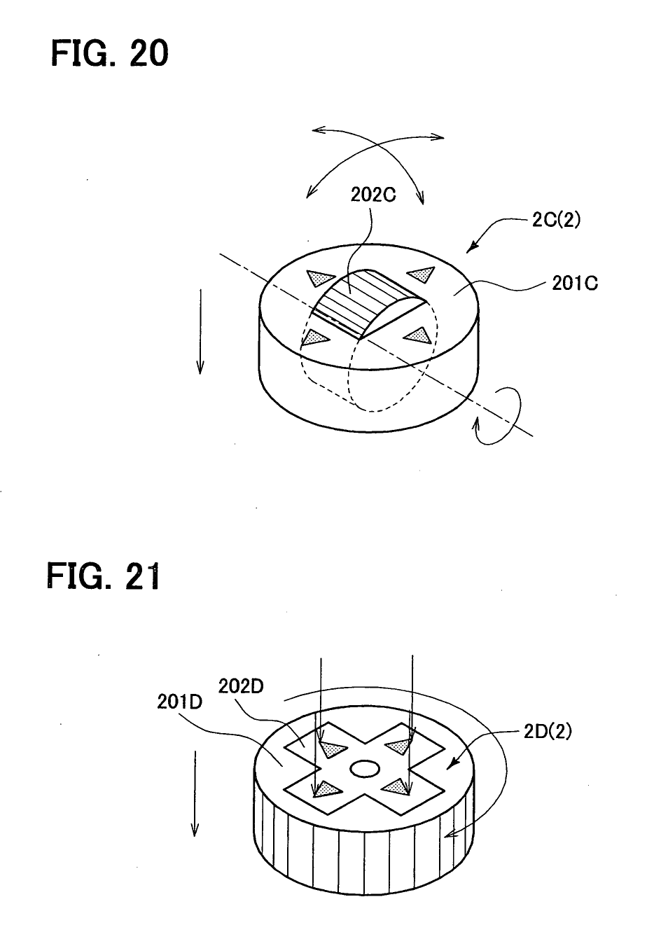

For example, FIG. 18 illustrates a manipulation device 2A(2) that contains a first manipulation knob 201A and a second manipulation knob 202A. The first manipulation knob 201A is stick-like shaped to shift to one of several predetermined shifting manipulation directions (e.g., four or eight directions). The second manipulation knob 202A is wheel-like shaped to be arranged in the first manipulation knob 201A; the second manipulation knob 202A is able to be rotated in reciprocal two forth-and-back directions and be pressed in the axis direction of the first manipulation knob 201A. In addition, FIG. 19 illustrates a manipulation device 2B(2) containing a stick-like shaped first manipulation knob 201B (similar to FIG. 18) and a trackball 202B arranged in the first manipulation knob 201B. In addition, FIG. 20 illustrates a manipulation knob 201C containing a first manipulation knob 201C responding to a shifting manipulation (a crisscross directional manipulation: see FIG. 3) and a pressing manipulation and a wheel-shaped second manipulation knob 202C responding to a rotating manipulation. In addition, FIG. 21 illustrates a manipulation knob 2D(2) containing a first manipulation knob 201D responding to a dial rotating manipulation and a pressing manipulation (like a device 20 in FIG. 3), and a second push-type crisscross switch manipulation knob 202D. In addition, a manipulation device may be designed to be any combination of the foregoing ones or a combination with another manipulation device.

In addition, in the present invention, the manipulation window 300 responding to a rotating manipulation manner may be designed to accept one of (i) a scale manipulation which enlarges and reduces a map on the screen 30, (ii) a selection manipulation to be accompanied by a scroll display, and (iii) a volume manipulation.

Further, in the above embodiment, for instance, the control circuit 10 may function as a selection region highlight display means or section to execute a display control to relatively highlight a display content of a selection region 310 selected by the selection manipulation, as compared with a display content of a residual selection region(s) 310 which is not selected: In addition, when an auxiliary image 320 is assigned to each of several selection regions 310, as explained in the above embodiment, the control circuit 10 may function as a first auxiliary image highlight display means or section to execute a display control to relatively highlight an auxiliary image 320 corresponding to a selection region 310 selected by the selection manipulation as compared with an auxiliary image corresponding to a residual selection region(s) 310 which is not selected. In addition, such relative highlight may be made simultaneously with respect to both the selected selection region 310 and the corresponding auxiliary image 320.

Further, the above embodiment is designed such that a determination input manipulation is made separate from a selection manipulation. However, a determination input manipulation can be made or completed simultaneously when a selection manipulation is made or completed. That is, the section manipulation can be designed to also serve as a determination input manipulation.

In addition, a vehicular manipulation apparatus according to the present invention can be provided as follows. Advent or occurrence of a predetermined scene in the vehicle is determined. When the occurrence of the scene is determined, a selection region 310 which should be recommended to accept a selection manipulation is specified as a recommendation region. When the recommendation region is specified, the control circuit 10 may execute a display control to emphasize or highlight an auxiliary image 320 indicating a manipulation direction for selecting the recommendation region as compared with the residual auxiliary image 320. In such a case, the control circuit 10 may function as a scene determination means or section, a recommendation region specification means or section, or a second auxiliary image highlight display means or section. For example, the display of the wavelike image or arrow image of the auxiliary image 320 may be changed in the magnitude, the movement speed, the color (one or some of a hue, a chroma saturation, and a brightness), etc. Such a configuration can provide an optimal control content according to the vehicle state or the peripheral condition, a screen change to the manipulation window (recommended) which should be selected, or urging of a selection manipulation and a determination input manipulation of the selection region 310 corresponding to the mode selection. This can expect an effective use of various in-vehicle devices 5.

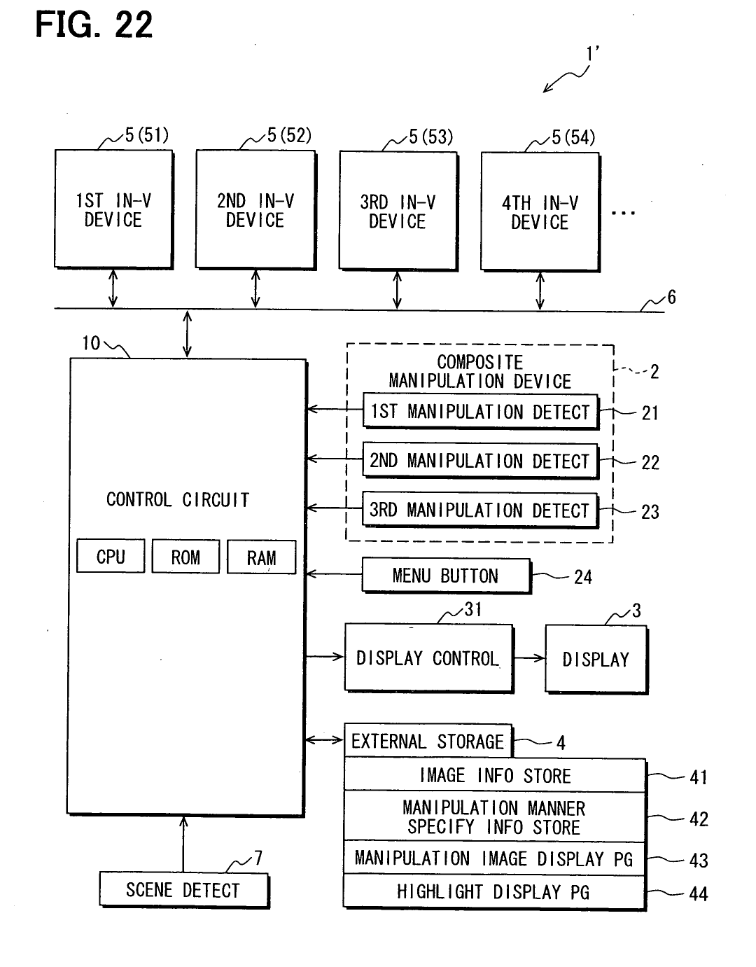

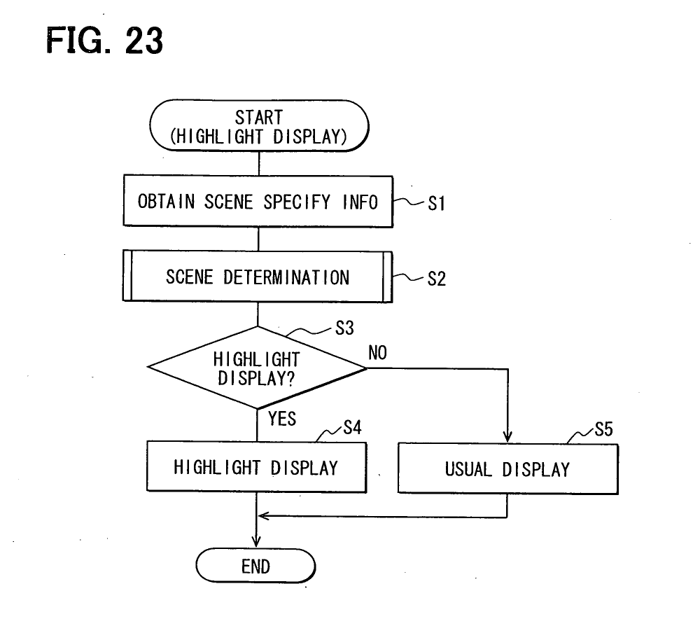

In detail, in a vehicular manipulation apparatus 1′ illustrated in FIG. 22, the control circuit 10 is connected with a specific scene detection device 7 which detects a predetermined scene in the vehicle, and executes a highlight display program 44 stored in the external storage device 4, enabling the highlight display. The flow of a process of the highlight display program 44 is illustrated in FIG. 23.

It is further noted that a flowchart or the processing of the flowchart in the present application includes sections (also referred to as steps), which are represented, for instance, as S1. Further, each section can be divided into-several sub-sections while several sections can be combined into a single section. Furthermore, each of thus configured sections can be referred to as a means or unit and achieved not only as a software device but also as a hardware device. First, at S1, the scene specific information for specifying a predetermined scene (highlight display scene) in the vehicle is acquired from the specific scene detection device 7. At S2, it is determined whether it is a predetermined scene. When it is determined that the predetermined scene comes at S3, the selection region 310 is specified which is defined in association with the scene or the selection region 310 for reaching the manipulation window 300 enabling the selection region 310. At S4, an auxiliary image 320 which indicates the manipulation direction for selecting the recommendation region in S4 is emphasized relatively as compared with the remaining auxiliary image 320. On the other hand, when it is determined that the predetermined scene does not come, the auxiliary image 320 remains as usual (S5). The above process is repeatedly executed with predetermined intervals.

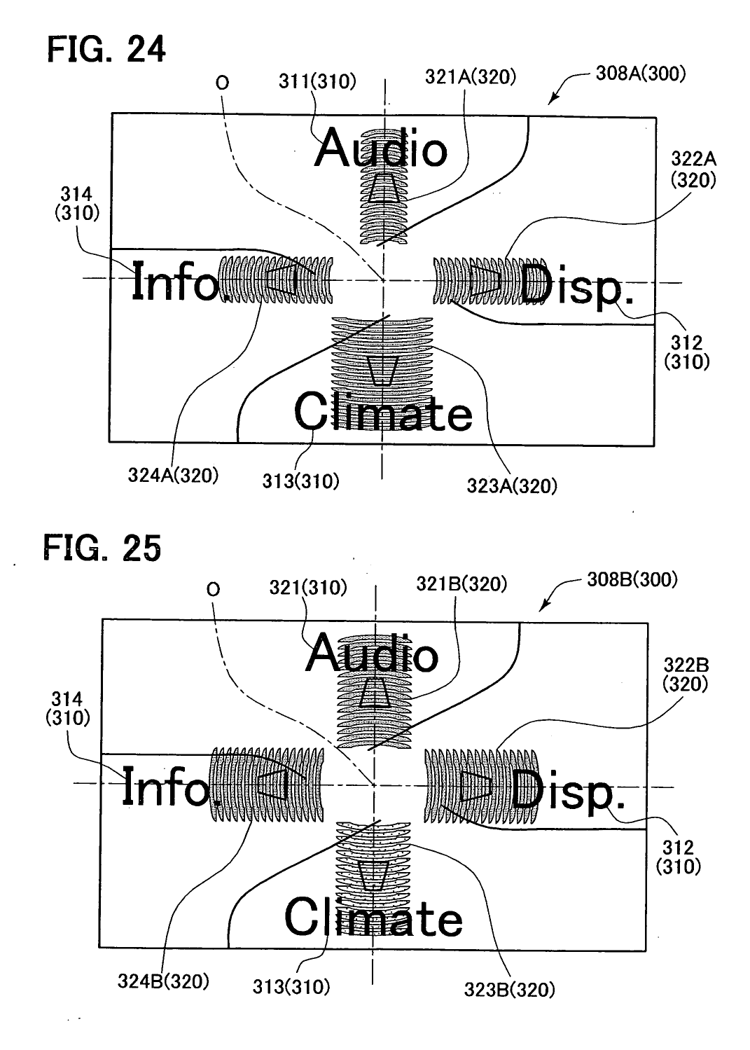

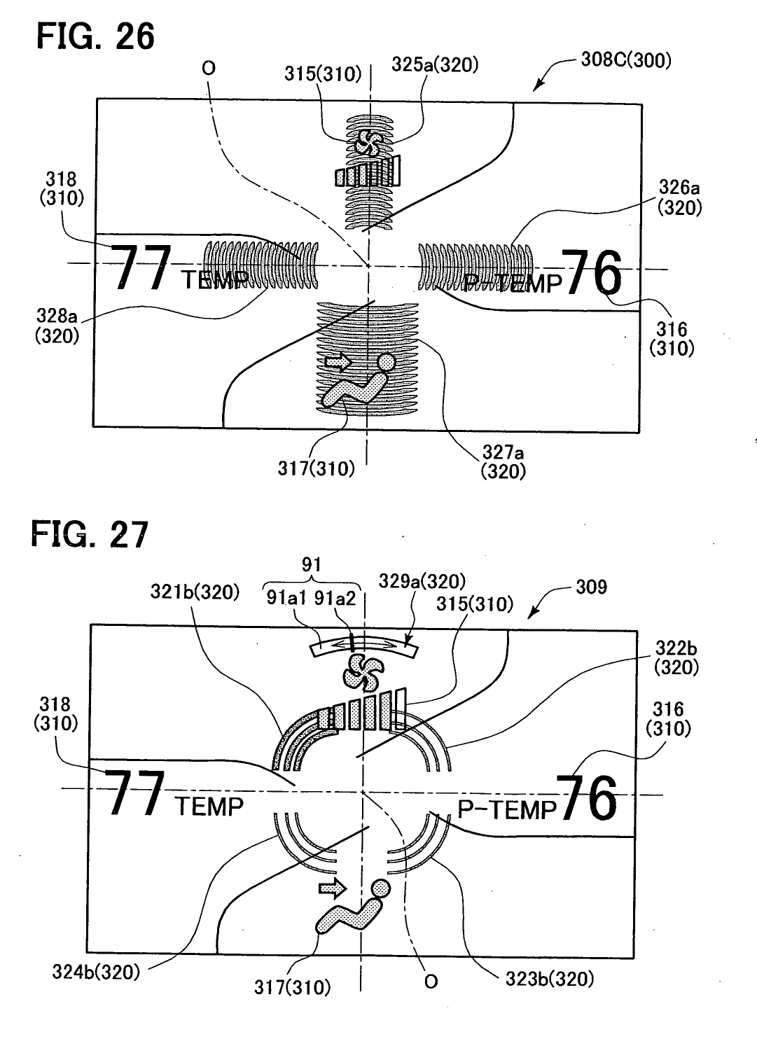

FIGS. 24 to 27 illustrate examples of highlight displays (S4). In FIG. 24 and FIG. 26, the auxiliary image 320 (323A, 327a) which goes to the recommendation region 310 (313,317) from the window reference position O is highlighted by making thicker (i.e., wider) than the residual auxiliary images 320. In FIG. 25, the color of the auxiliary image 320 (323B) which goes to the recommendation region 310 (313) from the window reference position O is highlighted by changing the color, which is different from that in the residual auxiliary images 320. In FIG. 27, the auxiliary image 321b (320) which goes to the recommendation region 318 (310) from the selection region 315 (310) under selection is highlighted by making thicker (i.e., wider) than the residual auxiliary-images 320.

The scene specified at S1 and S2 is a scene in which the reception sensitivity of the broadcasting signal becomes weak at the time of viewing and listening of television and radio, for example. The specific scene detection device 7 is a well-known reception sensitivity detector circuit in a tuner for detecting a reception sensitivity of a received broadcasting signal. When the detected reception sensitivity becomes less than a predetermined sensitivity, the control circuit 10 performs a highlight display to highlight relatively the auxiliary image 320 corresponding to the selection region to enable the transfer to the audio manipulation window as compared with the residual auxiliary images 320 so as to recommend the audio manipulation in the menu window 301. In addition, in the audio manipulation window, so as to recommend a manual frequency channel selection instead of the preset mode of the radio, the auxiliary image 320 corresponding to the selection region of the manual frequency channel selection is emphasized more relatively than the residual auxiliary image 320, thereby guiding (the manual channel selection is guided or recommended on the premise that other preset channels are unselectable out of the service area).

In addition, suppose a case that an external environment state outside of the vehicle is in a low temperature or rainy to thereby cause a windshield to easily mist while an in-vehicle air-conditioning apparatus is in an internal circulation mode and the A/C switch (air-conditioner SW) is set to the OFF state (compressor OFF). In such a case, when the climate mode is selected, so as to enable the NC switch to be set to the ON state (compressor ON), the auxiliary image 320 corresponding to the selection region corresponding to the A/C switch is highlighted relatively more than the residual auxiliary image 320, thereby guiding to help prevent a window from misting. The specific scene detection device 7 may be a raindrop sensor, a temperature sensor inside and outside of the vehicle, an internal air/outside air mode changeover switch, etc.

Aspects of the disclosure described herein are set out in the following clauses.

As an aspect of the disclosure, a vehicular manipulation apparatus in a vehicle is provided as follows. A display device is included. A main display control section is configured to cause the display device to display on a screen of the display device a manipulation window that contains a plurality of selection regions. A selection manipulation device is configured to allow a selection manipulation to select one of the selection regions in the displayed manipulation window. The selection manipulation device is a composite manipulation device to enable each of a plurality of manipulation manners to independently achieve the selection manipulation. An auxiliary image display control section is configured to cause the display device to perform a dynamic display that, displays on the manipulation window an auxiliary image that reflects a manipulation movement locus of the selection manipulation device, in order to indicate the manipulation manner corresponding to the manipulation window being displayed. Herein, the dynamic display performed by the auxiliary image display control section does not provide the selection regions with a superimposition continuation region, in which the auxiliary image is superimposed on the manipulation window continuously for a predetermined duration.

As an optional aspect, the auxiliary image display control section may be designed to perform a display so as to superimpose the auxiliary image, which is another image different from the display content of the selection region in the manipulation window, on the main image which illustrates the manipulation window.

This enables the display of the auxiliary image to have a relatively large size, thereby allowing easy recognition of the manipulation manner.

For instance, the auxiliary image display control section may be designed to perform a display of the auxiliary image, which is an auxiliary figure group containing several auxiliary figures in arrangement in a row. The direction of such arrangement of the auxiliary figures can indicate a manipulation movement locus in the manipulation manner by the selection manipulation device.

Furthermore, the moving display or dynamic display of the,auxiliary image can indicate the manipulation direction in the manipulation manner of the selection manipulation device responding to the manipulation window currently displayed. For example, the motion of the auxiliary figure group can be regarded as the motion to the direction of the manipulation movement locus or to the manipulation direction of the manipulation manner.

This allows the user to recognize quickly the manipulation manner, thereby advancing to the manipulation.

As an optional aspect, the auxiliary image display control section may be designed to display the auxiliary image in the state of semi transmission.

This allows the display content displayed mainly to be always visible; the display contents are not mistaken.

As an optional aspect, the composite manipulation device may be designed to enable at least two manipulation manners such as a rotating manipulation manner and a shifting manipulation manner. In the rotating manipulation manner, a first manipulation knob may be rotated around a predetermined rotation axis. In the shifting manipulation manner, a second manipulation knob may be shifted in a direction on a predetermined plane.

The rotating manipulation manner may be suitable for a map scale expansion/reduction manipulation, a scroll manipulation, and a volume control manipulation. The shifting manipulation manner may be suitable for indicating a position such as a sliding manipulation and a tilt manipulation. By providing both the manners, the usage of the composite manipulation device is significantly expandable. Further, the display of the auxiliary image can teach certainly how to differentiate those manipulation manners, thereby preventing the occurrence of the mis-manipulation.

In such a case, several selection regions may be displayed in one of or both of the manipulation window responding to the rotating manipulation manner and the manipulation window responding to the shifting manipulation manner. In the corresponding manipulation window, the selection regions may be provided to be in circular arrangement with predetermined intervals circumferentially with a predetermined window reference point centered.

When the manipulation images are positioned in circular arrangement with a certain point on the window centered, it is difficult to determine whether the manipulation images should be selected by a rotating manipulation such as a jog dial or by a sliding manipulation on a plane such as a crisscross manipulation. In the configuration according to the present aspect of the disclosure, the instantaneous selection of the suitable manipulation manner can be achieved without wavering in determining which manipulation manner should be used.

Furthermore, the composite manipulation device may be designed such that the second manipulation knob responding to the shifting manipulation manner is guided so as to shift in only several predetermined shifting manipulation directions.

For example, a guide portion may be provided so as to guide the shifting of the manipulation knob mechanically or to control the reactive force motor for restricting the shifting of the manipulation knob to the predetermined direction. This enables a user to easily perform the shifting manipulation to the predetermined shifting direction.

In addition, in such a case, on the manipulation window responding to the shifting manipulation manner, the selection regions may be disposed in a circular arrangement centering on the window reference point such that a relation of the manipulation reference position and each of the shifting manipulation directions in the composite manipulation device accords with a relation of the window reference point and each of the directions of the arrangement of the selection regions in the manipulation window.

In detail, the composite manipulation device may be designed to respond to a crisscross manipulation manner in which the shifting manipulation of the second manipulation knob responding to the shifting manipulation manner is enabled to shift to the four directions forming a shape of a crisscross centering on the above reference position (for example, manipulation neutral position) of the second manipulation knob. In such a case, on the manipulation window responding to the crisscross manipulation manner, the selection regions are arranged in the shape of the crisscross centering on the above window reference point. Under such a configuration, the arrangement position of the manipulation image on the manipulation window may be associated with a crisscross manipulation manner; in contrast, it may be mistakenly associated with a manipulation by a rotating manipulation manner. Accordingly, as already described, the display of the auxiliary image is used to prevent such a confusion effectively.

As an optional aspect, the composite manipulation device may be provided with a single manipulation know serving as both the above first manipulation knob and the second manipulation knob.

This can enable the composite manipulation apparatus to realize several manipulation manners by a single manipulation knob; thus, the choice to select one of the manipulation knobs is eliminated, thereby allowing the efficient manipulation.

As an optional aspect, the composite manipulation device may be configured to enable a determination input manipulation applied to a selection region which is selected by using another manipulation manner different from that of the selection manipulation such as a pushing manipulation different from a rotating manipulation or shifting manipulation.

In such a case, a first auxiliary, image highlight display section may be provided to display the auxiliary image corresponding to the selection region selected by the selection manipulation in a highlight manner as compared with other residual auxiliary images. In addition, in order to indicate that the selection region is in the selected state based on the selection manipulation, a manipulation image highlight display section may be provided to perform a highlight display to display the selection region, which is in the selected state, in a highlight manner as compared with other residual selection regions. According to the above highlight display sections, when executing the determination input manipulation in the composite manipulation device, the selected state of the selection region at the present time can be explicitly understood. This can prevent a mis-manipulation.

As an optional aspect, a scene determination section may be configured to determine whether a predetermined scene occurs in the vehicle, a recommendation region specification section may be configured to specify as a recommendation region a selection region to which a selection manipulation is recommended to be applied when the scene is determined to occur. Further, a second auxiliary image highlight section may be configured to display the auxiliary image, which indicates a manipulation direction for selecting the specified recommendation region, in a highlight manner compared with a residual selection region other than the selection region serving as the recommendation region.

According to such a configuration, in various different vehicular scenes (relating to a vehicle state or a peripheral condition), the selection region to which a manipulation is recommended can be emphasized using the above-mentioned auxiliary display. The method of the highlight display of the auxiliary image by the above first and second highlight display sections may be easily performed by varying the magnitude, the moving speed, or the color of the auxiliary image, for instance.

As another aspect of the disclosure, a vehicular manipulation apparatus is provided as follows. An image information storage device is configured to store image information on display for each of several manipulation windows. A manipulation Manner specification information storage device is configured to store manipulation manner specification information, which specifies a manipulation manner for a selection manipulation that is acceptable in a corresponding manipulation window being displayed, in association with the image information. A main display control section is configured to read the image information of the new manipulation window from the image information storage device and display the manipulation window based on the image information when the manipulation window is switched into a new manipulation window. A manipulation manner specification section is configured to read out the manipulation manner specification information corresponding to the image information of the new manipulation window from the manipulation manner specification information storage device and specify the manipulation manner of the manipulation window displayed based on the image information when the manipulation window is switched into the new manipulation window. A manipulation manner designation section is configured to designate an input of a selection manipulation in the specified manipulation manner by the composite manipulation device to be receivable. An auxiliary image display control section is configured to display as a varying image an auxiliary image reflecting a manipulation movement locus in the manipulation manner of the selection manipulation device in order to indicate the manipulation manner corresponding to the manipulation window being displayed. Herein, the varying image or dynamic image displayed by the auxiliary image display control section does not have a superimposition continuation region, in which the auxiliary image continues to be superimposed on the selected region for a predetermined duration. The various manipulation windows may have selection regions in a variety of the arrangement positions. Further, various manipulation manners may be adopted. According to the above configuration, even if the display window is switched into any new manipulation window, the new manipulation window can be specified each time. The suitable arrangement of the selection regions and the display of the auxiliary image can be achieved.

In the present disclosure, the composite manipulation device may be formed in a position different from a position of a display screen or display window on the display screen of the main display control section. the composite manipulation device may be thus designed to be a remote manipulation device or means for remotely executing the manipulation input in the manipulation window.

It will be obvious to those skilled in the art that various changes may be made in the above-described embodiments of the present invention. However, the scope of the present invention should be determined by the following claims.

What is claimed:

1. A vehicular manipulation apparatus in a vehicle, the apparatus comprising:
a display device;
a main display control section configured to cause the display device to display on a screen a manipulation window that contains a plurality of selection regions;
a selection manipulation device configured to allow a selection manipulation to select one of the selection regions in the displayed manipulation window, the selection manipulation device being a composite manipulation device to enable each of a plurality of manipulation manners to independently achieve the selection manipulation; and
an auxiliary image display control section configured to cause the display device to perform, a dynamic display that displays on the manipulation window an auxiliary image that reflects a manipulation movement locus of the selection manipulation device, in order to indicate the manipulation manner corresponding to the manipulation window being displayed,
wherein the dynamic display performed by the auxiliary image display control section does not provide the selection regions with a superimposition continuation region, in which the auxiliary image is superimposed on the manipulation window continuously for a predetermined duration.

2. The vehicular manipulation apparatus according to claim 1, wherein
the auxiliary image display control section displays as the auxiliary image an additional image in superimposition on a main image displaying the manipulation window, the additional image having a display content different from a display content of the selection region of the manipulation window.

3. The vehicular manipulation apparatus according to claim 2, wherein:
the auxiliary image display control section displays as the auxiliary image an auxiliary figure group which contains a plurality of auxiliary figures, which are in arrangement in a row; and
a direction of the arrangement of the auxiliary figures indicates a manipulation movement locus of the selection manipulation device in the manipulation manner corresponding to the manipulation window being displayed.

4. The vehicular manipulation apparatus according to claim 3, wherein
the auxiliary image display control section indicates a manipulation direction of the selection manipulation device in the manipulation manner corresponding to the manipulation window being displayed, by using a movement display of moving towards the direction of the arrangement of the auxiliary figures contained in the auxiliary figure group.

5. The vehicular manipulation apparatus according to claim 1, wherein
the auxiliary image display control section displays the auxiliary image in a semi transmission state.

6. The vehicular manipulation apparatus according to claim 1, wherein:
the selection manipulation device being the composite manipulation device enables at least two manipulation manners including a rotating manipulation manner and a shifting manipulation manner,
the rotating manipulation manner in which a first manipulation knob is rotated around a predetermined rotation axis,
the shifting manipulation manner in which a second manipulation knob is shifted in a direction on a predetermined plane; and
in one or both of a manipulation window responding to the rotating manipulation manner and a manipulation window responding to the shifting manipulation manner, the displayed selection regions are arranged with predetermined intervals along a circumference of a circle centering on a predetermined window reference point in the corresponding manipulation window.

7. The vehicular manipulation apparatus according to claim 6, wherein
the first manipulation knob and the second manipulation knob are integrated as a single manipulation knob.

8. The vehicular manipulation apparatus according to claim 6, wherein:
the selection manipulation device being the composite manipulation device is configured to enable the second manipulation knob, which is responding to the shifting manipulation manner, to shift from a predetermined reference position only to a plurality of predetermined shifting manipulation directions; and
in the manipulation window responding to the shifting manipulation manner, the selection regions are disposed in a circular arrangement centering on the window reference point such that a relation of the predetermined reference position and each of the shifting manipulation directions in the composite manipulation device corresponds to a relation of the predetermined window reference point and each of the directions of the arrangement of the selection regions in the manipulation window.

9. The vehicular manipulation apparatus according to claim 8, wherein
the shifting manipulation manner is a crisscross manipulation manner in with the shifting manipulation, directions are only four directions configuring a crisscross shape centering on the predetermined reference position.

10. The vehicular manipulation apparatus according to claim 1, wherein
the selection manipulation device being the composite manipulation device is enabled to perform a determination input manipulation to the selected selection region by using a manipulation manner different from the manipulation manner used in the selection manipulation.

11. The vehicular manipulation apparatus according to claim 1,
wherein the auxiliary image is provided to correspond to each of the selection regions,
the apparatus further comprising:
a first auxiliary image highlight display section configured to display the auxiliary image corresponding to the selection region selected by the selection manipulation in a highlight manner as compared with a residual auxiliary image which is different from the selection region selected by the selection manipulation.

12. The vehicular manipulation apparatus according to claim 1, further comprising:
a scene determination section configured to determine whether a predetermined scene occurs in the vehicle;
a recommendation region specification section configured to specify as a recommendation region a selection region to which a selection manipulation is recommended to be applied when the scene is determined to occur; and
a second auxiliary image highlight display section configured to display the auxiliary image, which a manipulation direction for selecting the specified recommendation region, in a highlight manner as compared with a residual selection region other than the selection region serving as the recommendation region.
